(19) United States
(12) Patent Application Publication
(10) Pub. No.: US 2006/0138804 A1
(43) Pub. Date: Jun. 29, 2006

(54) Modular cowl assembly for forklift trucks

(76) Inventor: Seung Jegal, Gyeyang-Gu (KR)

Correspondence Address: Heather M. Barnes;Brouse McDowell, Suite 500, 388 South Main Street, Akron, OH, 44311-4407, US

(21) Appl. No.: 11/337,051

(22) Filed: Dec. 23, 2005

(30) Foreign Application Priority Data
Dec. 28, 2004 (KR) 10-2004-0114276

(51) Int. Cl. B62D 25/08

(52) U.S. Cl. 296/192

(57) ABSTRACT

An easy-to-handle modular cowl assembly for forklift trucks includes a cowl body mounted on a truck body, a console at least partially enclosing and removably holding a variety of driver interface devices, a support bracket for supporting the console on the cowl body, a right cowl cover disposed at a right side of the console, a left cowl cover disposed at a left side of the console, a cowl cover fastener means for securing the right cowl cover and the left cowl cover to the cowl body, a right end cover disposed at an outer open end side of the right cowl cover, a left end cover disposed at an outer open end side of the left cowl cover, and an end cover fastener means for securing the right end cover and the left end cover to the right cowl cover and the left cowl cover, respectively.

### FIELD OF THE INVENTION

The present invention is directed to a modular cowl assembly mounted on a front part of forklift trucks, and more specifically, to a modular cowl assembly for forklift trucks that combine a cowl with a steering column, an instrument board, a parking handle and other diver interface devices in a single module and thus can be transported, handled and mounted on forklift trucks in a simple and convenient manner regardless of the kinds of the forklift trucks to which is applied the modular cowl assembly.

### BACKGROUND OF THE INVENTION

Provided in front of a driver's compartment of forklift trucks are a cowl, a console, a parking brake handle and a variety of instrument boards, of which the console encloses or holds driver interface devices such as a steering wheel, a forward-reverse lever, a direction indicator lever and the like. Typically, the driver interface devices are attached to the body of the forklift trucks independently of the cowl.

The task of mounting the cowl on the truck body is first carried out prior to attaching the driver interface control devices to the truck body. This makes it unavoidable for an operator to perform his or her tasks of attaching the interface devices within a narrow working space, thus making the operator's works quite laborious and time-consuming.

Furthermore, the cowl and the interface devices attached to the cowl are differently shaped and sized depending on the kinds of the forklift trucks. This requires the operator to carry Out different kinds of attachment works on a truck-by-truck basis, which involves highly cumbersome, time-consuming and inefficient working processes.

### SUMMARY OF THE INVENTION

Taking into account the afore-mentioned and other problems of the state-of-the-art technology, it is an object of the present invention to provide a modular cowl assembly for forklift trucks that, by combining a cowl with a steering column, an instrument board, a parking handle and other diver interface devices in a single module, can be transported, handled and mounted on forklift trucks in a simple and convenient manner with increased interchangeability regardless of the kinds of the forklift trucks to which is applied the modular cowl assembly.

With these objects in view, the present invention provides a modular cowl assembly for forklift trucks, comprising: a cowl body mounted on a truck body in front of a driver's compartment; a console at least partially enclosing and holding a steering column, a direction indicator lever and a forward-reverse lever; a support bracket for supporting the console on the cowl body; a right cowl cover disposed at a right side of the console for covering at least a part of the cowl body; a left cowl cover disposed at a left side of the console for covering at least a part of the cowl body; a cowl cover fastener means for securing the right cowl cover and the left cowl cover to the cowl body; a right end cover disposed at an outer end side of the right cowl cover for closing an open end of the right cowl cover; a left end cover disposed at an outer end side of the left cowl cover for closing an open end of the left cowl cover; and an end cover fastener means for securing the right end cover and the left end cover to the right cowl cover and the left cowl cover, respectively.

In a preferred embodiment of the present invention, it is desirable that the modular cowl assembly further comprise an instrument board affixed to the right cowl cover.

In a preferred embodiment of the present invention, it is desirable that the modular cowl assembly further comprise a parking brake lever swingably attached to the left cowl cover.

In a preferred embodiment of the present invention, it is desirable that each of the right end cover and the left end cover have a length varying with the kinds of forklift trucks to which is applied the modular cowl assembly.

In a preferred embodiment of the present invention, it is desirable that each of the cowl cover fastener means and the end cover fastener means comprise a screw.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is an exploded perspective view showing a modular cowl assembly for forklift trucks in accordance with the present invention;

FIG. 2 is a rear perspective view showing a right cowl cover and a right end cover joined together by a fastener means in a modular cowl assembly for forklift trucks of the present invention;

FIG. 3 is a rear perspective view showing a left cowl cover and a left end cover joined together by a fastener means in a modular cowl assembly for forklift trucks of the present invention; and

FIG. 4 is a perspective view showing a modular cowl assembly for forklift trucks in accordance with the present invention, with their parts joined together.

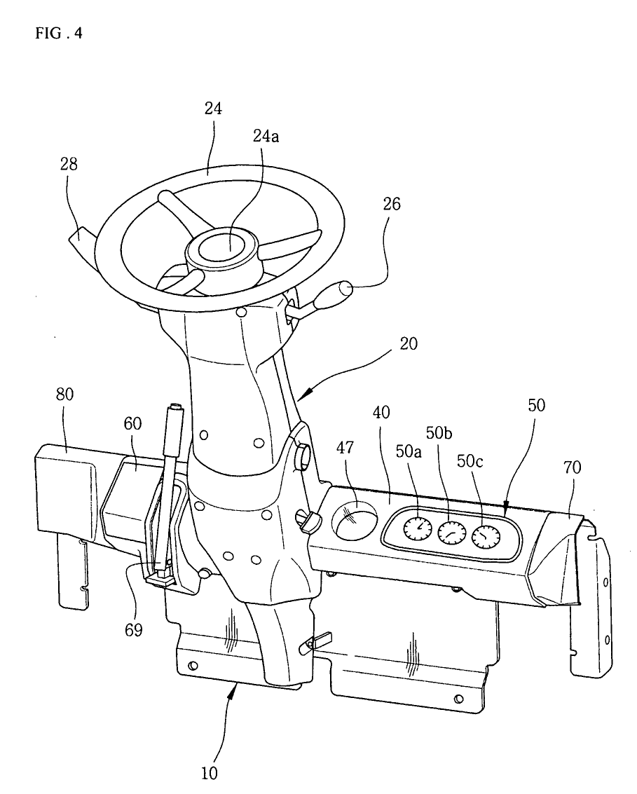

### DETAILED DESCRIPTION OF THE INVENTION

A preferred embodiment of a modular cowl assembly for forklift trucks in accordance with the present invention will now be described in detail with reference to the accompanying drawings.

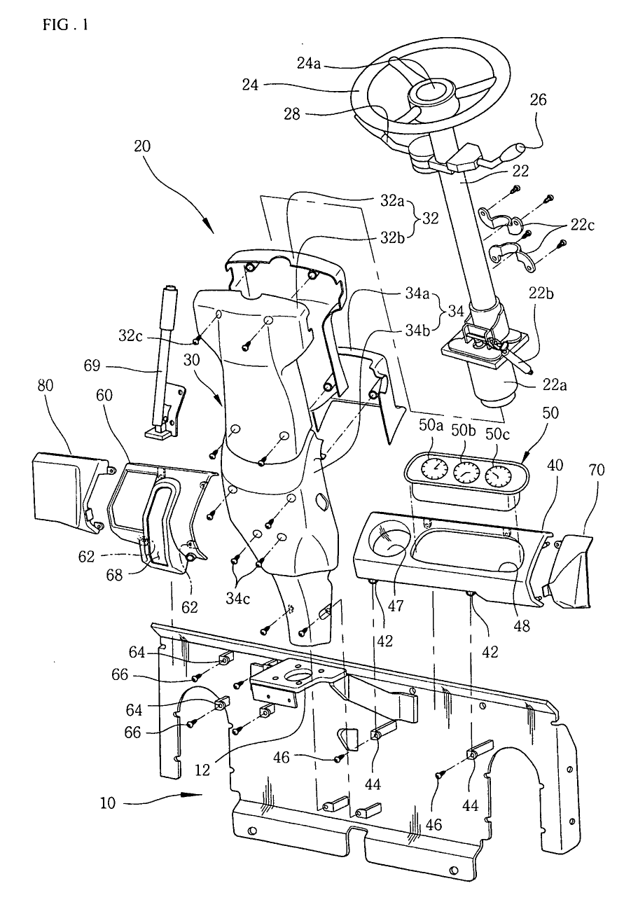

Referring first to FIG. 1, a modular cowl assembly for forklift trucks includes a cowl body 10 which provides a base for supporting a variety of driver interface devices in front of a driver's compartment of, e.g., forklift trucks. The cowl body 10 is removably mounted on a truck body (not shown) and composed of a material with high strength such as a press-formed metal plate and an injection-molded synthetic resin.

A console 20 is attached to the center area of the cowl body 10. The console 20 serves to partially enclose or hold a steering column 22, a direction indicator lever 26 and a forward-reverse lever 28. Attached to the top end of the steering column 22 is a steering wheel 24 that has a buzzer button 24a at its center. The steering column 22 is tiltably attached to a support bracket 12 of the cowl body 10 and can be tilted forwards or rearwards by the action of a tilting cylinder 22b into an angular position selected by a driver.

The console 20 is provided with a console cover 30 enclosing the most part of the steering column 22. The console cover 30 consists of a top cover 32 which is divided into first and second split cover parts 32a, 32b and a bottom cover 34 which is also divided into first and second split cover parts 34a, 34b.

The second split cover part 32b of the top cover 32 is attached to the steering column 22 by means of a support bracket 22c and then secured to the first split cover parts 32a by virtue of a screw 32c, thus joining the top cover 32 and the steering column 22 together. Similarly, the first and second split cover parts 34a, 34b of the bottom cover 34 are joined together by means of a screw 34c and the bottom cover 34 thus joined is secured to the cowl body 20.

Referring again to FIG. 1, the modular cowl assembly of the present invention includes a right cowl cover 40 disposed at the right side of the console 20 and affixed to the cowl body 10 by a fastener means. The fastener means comprises a plurality of first fixing lugs 42 integrally formed with the right cowl cover 40, a plurality of second fixing lugs 44 integrally formed with the cowl body 10 in alignment with the first fixing lugs 42, and fixing screws 46 for combining the first fixing lugs 42 and the second fixing lugs 44 together.

The right cowl cover 40 is provided with an inwardly recessed storage pocket 47 and an elongated opening 48 formed through the thickness of the right cowl cover 40. The storage pocket 47 serves to store small articles such as cups, coins, clips and the like for ready use. The elongated opening 48 is adapted for receiving an instrument board 50 that includes, for example, a cooling water temperature indicator 50a, a transmission oil temperature indicator 50b, a fuel indicator 50c, an engine preheat indicator (not shown) and the like. The instrument board 50 is electrically associated with a controller (not shown) mounted on a truck body.

The modular cowl assembly of the present invention includes a left cowl cover 60 disposed at the left side of the console 20 and affixed to the cowl body 10 by a fastener means. The fastener means comprises a plurality of first fixing lugs 62 integrally formed with the left cowl cover 60, a plurality of second fixing lugs 64 integrally formed with the cowl body 10 in alignment with the first fixing lugs 62, and fixing screws 66 for combining the first fixing lugs 62 and the second fixing lugs 64 together.

The left cowl cover 60 is provided with a slot 68 formed through the thickness thereof for swingably receiving a parking brake lever 69. The parking brake lever 69 can be pulled by the driver when he or she wishes to place the forklift truck in a parking condition. The parking brake lever 69 is operatively connected to a brake (not shown) with a cable so that, when pulled, it can cause the brake to arrest a driving axle against rotation.

Furthermore, the modular cowl assembly of the present invention includes a right end cover 70 disposed at an outer end side of the right cowl cover 40 for closing an open end of the right cowl cover 40 and a left end cover 80 disposed at an outer end side of the left cowl cover 60 for closing an open end of the left cowl cover 60.

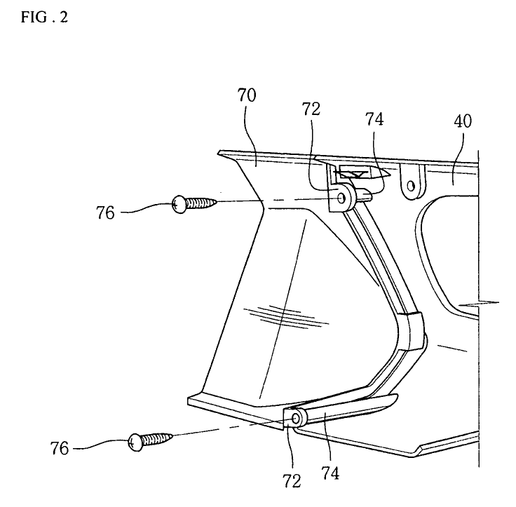

As best shown in FIG. 2, the right end cover 70 is attached to the right cowl cover 40 by means of a fastener means. The fastener means comprises a plurality of fixing ears 72 integrally formed with the right end cover 70, a plurality of fixing bosses 74 integrally formed with the right cowl cover 40 in alignment with the fixing ears 72, and fixing screws 76 for combining the fixing ears 72 and the fixing bosses 74 together.

The right end cover 70 of such configuration is so positioned at the outer end side of the right cowl cover 40 as to close the open end of the right cowl cover 40. This prevents foreign matters from infiltrating into the interior space of the right cowl cover 40

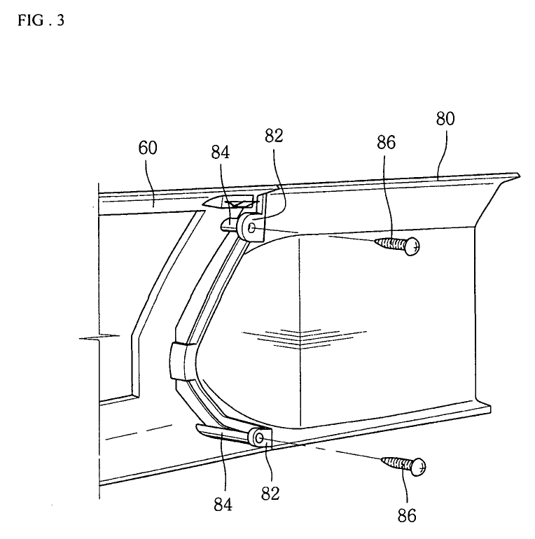

As clearly illustrated in FIG. 3, the left end cover 80 is attached to the left cowl cover 60 by means of a fastener means. The fastener means comprises a plurality of fixing ears 82 integrally formed with the left end cover 80, a plurality of fixing bosses 84 integrally formed with the left cowl cover 60 in alignment with the fixing ears 82, and fixing screws 86 for combining the fixing ears 82 and the fixing bosses 84 together.

The left end cover 80 of such configuration is so positioned at the outer end side of the left cowl cover 60 as to close the open end of the right cowl cover 60. This prevents foreign matters from infiltrating into the interior space of the left cowl cover 60.

Each of the right end cover 70 and the left end cover 80 is designed to have a length that varies with the kinds of forklift trucks to which is applied the modular cowl assembly. In other words, the right end cover 70 and the left end cover 80 are produced in multiple numbers in correspondence to the kinds of forklift trucks. Alternatively, the right end cover 70 and the left end cover 80 may be length-adjustably produced by use of, e.g., a bellows or other extendible components.

The modular cowl assembly of the present invention as configured above incorporates a cowl body 10 and a variety of driver interface devices, such as a steering column 22, a steering wheel 24, a direction indicator lever 26, a forward-reverse lever 28, a parking brake lever 69 and an instrument board 50, in a single module. The modular cowl assembly thus produced is transported, handled and attached to the truck body as a unit in the process of manufacture and assembly of the forklift trucks.

As described in the foregoing, the present invention provides a beneficial effect in that, by combining a cowl with a steering column, an instrument board, a parking handle and other diver interface devices in a single module, the modular cowl assembly can be transported, handled and mounted on forklift trucks in a simple and convenient manner with increased interchangeability regardless of the kinds of forklift trucks to which is applied the modular cowl assembly.

Although one preferred embodiment of the present invention has been described in detail hereinabove, it will be apparent to those skilled in the art that various changes or modifications may be made thereto within the scope of the invention defined by the appended claims.

What is claimed is:

1. A modular cowl assembly for forklift trucks, comprising:
a cowl body (10) mounted on a truck body in front of a driver's compartment;
a console (20) at least partially enclosing and holding a steering column (22), a direction indicator lever (26) and a forward-reverse lever (28);
a support bracket (12) for supporting the console (20) on the cowl body (10);
a right cowl cover (40) disposed at a right side of the console (20) for covering at least a part of the cowl body (10);
a left cowl cover (60) disposed at a left side of the console (20) for covering at least a part of the cowl body (10);
a cowl cover fastener means for securing the right cowl cover (40) and the left cowl cover (60) to the cowl body (10);
a right end cover (70) disposed at an outer end side of the right cowl cover (40) for closing an open end of the right cowl cover (40);
a left end cover (80) disposed at an outer end side of the left cowl cover (60) for closing an open end of the left cowl cover (60); and
an end cover fastener means for securing the right end cover (70) and the left end cover (80) to the right cowl cover (40) and the left cowl cover (60), respectively.

2. The modular cowl assembly as recited in claim 1, further comprising an instrument board (50) affixed to the right cowl cover (40).

3. The modular cowl assembly as recited in claim 1, further comprising a parking brake lever (69) swingably attached to the left cowl cover (60).

4. The modular cowl assembly as recited in claim 2, further comprising a parking brake lever (69) swingably attached to the left cowl cover (60).

5. The modular cowl assembly as recited in claim 1, wherein each of the right end cover (70) and the left end cover (80) has a length varying with the kinds of forklift trucks to which is applied the modular cowl assembly.

6. The modular cowl assembly as recited in claim 1, wherein each of the cowl cover fastener means and the end cover fastener means comprises a screw.
